(19) United States
(12) Patent Application Publication
(10) Pub. No.: US 2018/0371830 A1
(43) Pub. Date: Dec. 27, 2018

(54) COMBINED INSULATED GLAZING AND VENETIAN BLIND SYSTEMS

(71) Applicant: Pellini S.p.A., Codogno (IT)

(72) Inventors: Giovanni NICOLOSI, Dresano (MI) (IT); Alessandro PELLINI, Codogno (LO) (IT)

(21) Appl. No.: 16/062,788

(22) PCT Filed: Nov. 18, 2016
(86) PCT No.: PCT/IB2016/056948

§ 371 Date: Jun. 15, 2018

(30) Foreign Application Priority Data
Dec. 22, 2015 (IT) 102015000086662

(51) Int. Cl. E06B 9/264; E06B 9/326; E06B 9/382; E06B 9/303

(52) U.S. Cl. CPC E06B 9/264; E06B 9/326; E06B 2009/2643; E06B 9/303; E06B 9/382

(57) ABSTRACT

The present disclosure concerns a combined insulated glazing and Venetian blind system, the insulated glazing (2) comprising two glass panes and a spacer element, said two glass panes and said spacer element defining a closed volume, said Venetian blind (3) being situated within said closed volume, said Venetian blind (3) comprising an upper structure (6), a plurality of slats (4), each comprising at least two through holes (41), and at least two lift cords (5), operably associated with said upper structure (6), which extend through said holes (41) of said slats (4) and are operably configured to allow said slats (4) to move between a stowed position, in which said slats (4) accumulate proximate to said upper structure (6) and a deployed position, The lift cords (5) are characterized by comprising an inner core (51) enclosed in an outer braid (52), said inner core (51) being made of heat-set polyester and said outer braid (52) being made of ultra-high molecular weight polyethylene fibers (UHMWPE).

### FIELD OF THE INVENTION

The present disclosure relates to a combined insulated glazing and Venetian blind system with wear-resistant cords as defined in the preamble of claim 1.

### DISCUSSION OF THE RELATED ART

The provision of insulated glazing units with integrated Venetian blinds is known in the art. Insulated glazing units, which are usually employed as windows to separate an outdoor environment from an indoor environment, comprise two parallel glass panes and a spacer element. The space between the two glass panes is hermetically sealed, and may contain air or, more preferably, various types of gases, such as argon and krypton, according to the desired properties.

As compared with traditional windows, such insulated glazing units improve heat and sound insulation and may have a greater mechanical strength and afford higher safety.

Blinds, such as Venetian blinds, may be provided inside an insulated glazing unit to block light. As they are located within the insulated glazing unit, they are protected from accidental damage and can have a compact design, while reducing overheating of the indoor environment by preventing direct passage of light.

Venetian blinds comprise a plurality of slats, an upper structural element, two or more lift cords and two or more ladders. The ladders in turn comprise two upright members attached to the upper element and a series of equally spaced connecting links attached to the upright members.

The slats lie on such connecting links and have holes with at a given pitch.

The lift cords are operably attached to the upper element and extend through the holes in the slats.

Such lift cords, as well as the ladders, may be moved by the users in various manners, such as:
by a direct action on portions of such cords which extend from the upper structure;
by rotation of special rods;
by remote electronic control using a motor.

The actuation of the lift cords allows the slats to slide between a stowed position and a deployed position. Particularly, in the stowed position the slats may accumulate proximate to the upper structural element, thereby allowing light to pass through the window, whereas in the deployed position the slats may be dropped down to cover a desired portion of the window.

The actuation of the ladder allows orientation of the slats, which will modulate the passage of light through the Venetian blind; there will be particularly an orientation in which no light is allowed to pass and an orientation allowing the passage of a maximum amount of light. The slats are oriented by the relative vertical sliding movement of the two upright members, which tilts the connecting links.

These Venetian blinds are prone to wear, which may possibly cause the lift cords and the connecting links of the ladders to break.

Namely:
as the lift cord is moved it will be deteriorated by rubbing against the holes of the slats, which are generally sharp as they are formed by punching;
the movement of the ladders causes deterioration of the connecting links rubbing against the edges of the slats.

The deterioration and resulting failure of the lift cords or connecting links may involve the need to replace the whole combined insulated glazing and Venetian blind system.

Documents WO2015005983 teaches how to form lift cords that can extend the life of Venetian blinds. For this purpose, ultra-high molecular weight polyethylene fibers (UHMWPE) are employed.

Nevertheless, cords made of such materials have other drawbacks that make them unsuitable for use in insulated glazing units.

A first drawback is encountered when, during hot weather, the sun light impinging on the Venetian blind heats the insulated glazing unit. Due to the heat insulation properties of the insulated glazing unit, the heat thereof is hardly dissipated, and the insulated glazing unit may reach a temperature of 70°−80° C.

Also, UHMPWE have been found to shrink under such temperatures. Shrinking of the lift cords will cause the Venetian blind to cover a smaller portion of the glass panes of the insulated glazing unit. This effect is particularly undesired in hot weather, as it causes heating of the indoor environment.

A second drawback observed in lift cords made of UHMWPE is caused by the rigidity of this material. At the Venetian blind is moved, the chords must be able to be wound around bobbins (or tubes or spools) and be later unwound therefrom. When the lift cords are unwound, they should extend to a perfectly straight position, and simply under the weight of the slats.

These lift cords made of UHMWPE fibers tend to memorize the shape of the bobbins around which they are wound. Therefore, as the cords are unwound they may exhibit a “spring-like” behavior, which will prevent records to extend to a straight position. This will seriously hinder actuation of the slats, which will result in obvious and imaginable consequences.

In case of slat jamming, no direct action can be made thereupon because the Venetian blind is inside the insulated glazing unit. Therefore, the jamming condition can be only solved by replacing the entire combined insulated glazing and venetian blind system, and incurring the corresponding costs.

Furthermore, the problem of lift cord rigidity may also hinder the assembly of cords in the Venetian blind, still due to their difficulty to extend to a straight position. Particularly, during these operations, undesired folds and flaws are observed, which prevent the assembly process to be carried out quickly.

### SUMMARY OF THE INVENTION

The object of the present invention is to provide a Venetian blind that obviates the aforementioned drawbacks, as defined in claim 1.

### Advantages of the Invention

In one embodiment, the resulting blind will have a higher reliability and a longer life as compared with prior art blinds.

### BRIEF DESCRIPTION OF THE DRAWINGS

The characteristics and advantages of the present disclosure will appear from the following detailed description of a possible practical embodiment, illustrated as a non-limiting example in the set of drawings, in which:

FIG. 1 is a perspective view of a combined insulated glazing and Venetian blind system;

FIG. 2 is a perspective view of a part of the Venetian blind of FIG. 1;

FIG. 3 is a sectional view of a portion of a lift cord of the Venetian blind of FIG. 1, according to the present invention;

FIG. 4 is a lateral view of a part of the Venetian blind of FIG. 1;

FIG. 5 is a perspective view of a portion of a ladder of the Venetian blind of FIG. 1.

### DETAILED DESCRIPTION

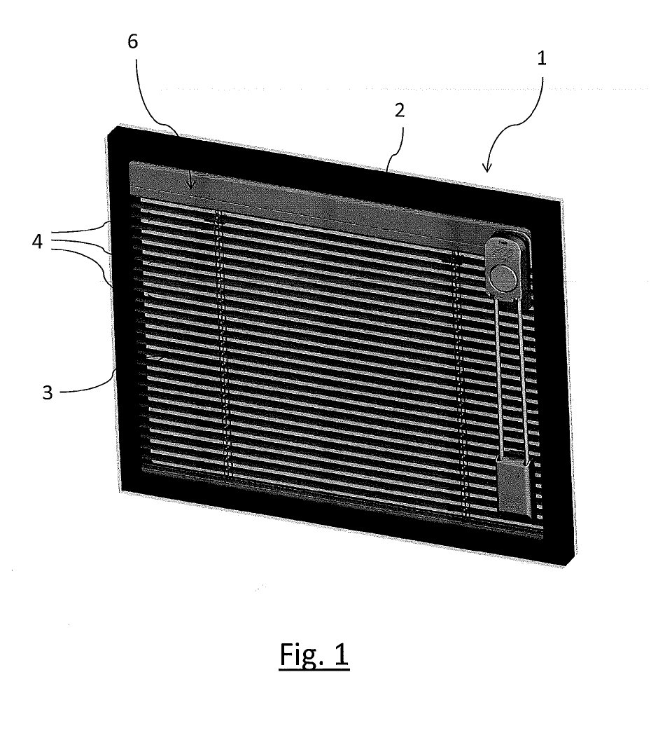

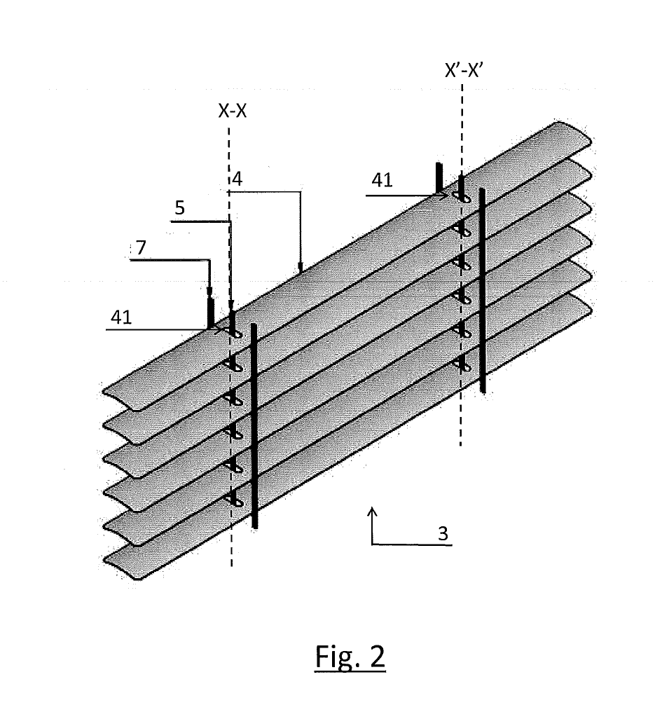

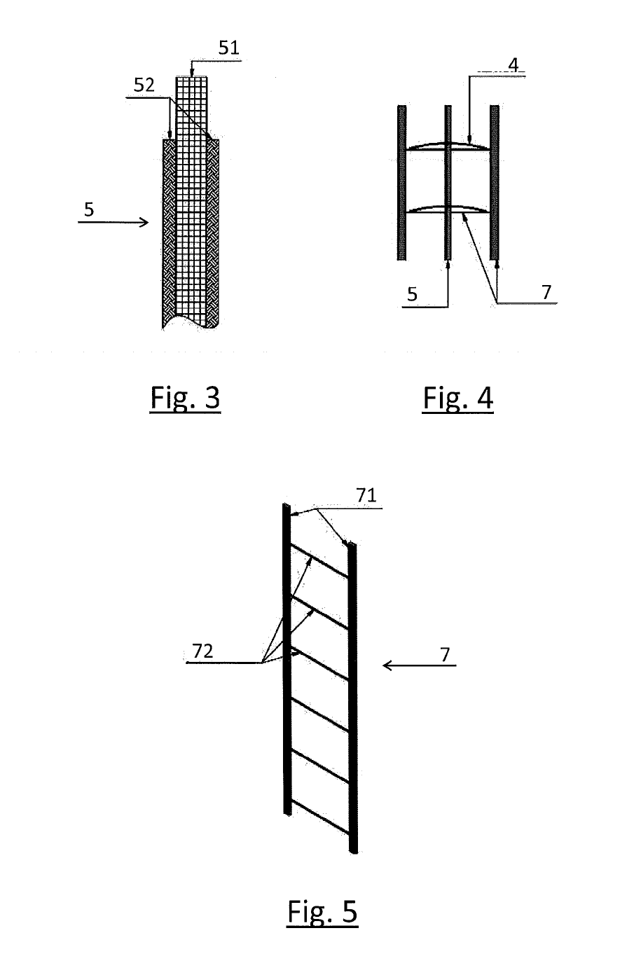

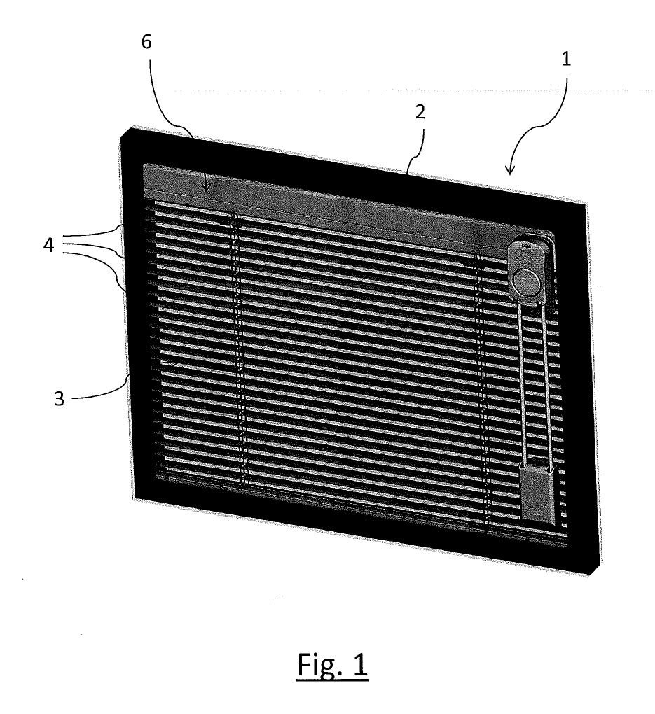

Referring to FIG. 1, numeral 1 designates the assembly composed of an insulated glazing unit 2 and a Venetian blind 3.

The insulated glazing unit 2 comprises, as is known per se, a first glass pane and a second glass pane as well of the spacer element, which will define substantially hermetically sealed volume which is designed to contain:
the Venetian blind 3,
air or more preferably noble gases such as argon or krypton, which are characterized by lower heat transfer coefficients as compared with air, for significant enhancement of heat.

The insulated glazing system 2 is designed to be mounted to a frame which is in turn adapted to be placed in a wall of a building.

As used hereinafter, the term “within the insulated glazing unit” relates to the insulated glazing unit 2 as installed, therefore the term “within the insulated glazing unit” shall be intended as the closed volume that is defined by the two glass panes at the sides, and by the spacer element above and below, with the terms above and below relating to the lying plane, i.e. the plane in which the insulated glazing 2 is installed.

The spacer element comprises a first surface designed for coupling with the first glass pane and a second surface designed for coupling with the second glass pane. The first surface and the second surface are parallel and preferably opposite to each other.

The spacer element is preferably made of a low heat conductivity material, such as natural or synthetic rubber. This will provide a spacer element characterized by a low linear heat transfer coefficient, which will reduce the emission of gas to the atmosphere at the peripheral frame, i.e. where the spacer is mounted.

Alternatively, the material of the spacer element may comprise silicone foam and/or the like, or any other commercially available material having similar properties.

The Venetian blind 3, as installed, is located within the insulated glazing unit 2.

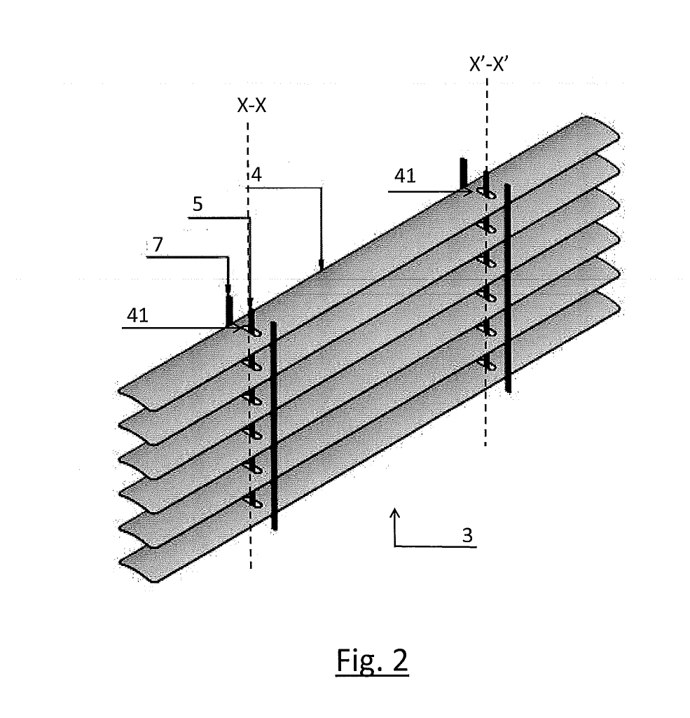

Referring to FIG. 2, the Venetian blind 3 comprises a plurality of slats 4, at least two lift cords 5 and a structure 6 (this is FIG. 1) situated in the upper portion of the Venetian blind 3.

The upper structure 6 is embodied by a box in which, as is known per se, the usual devices for moving the blind 3 are accommodated.

Such box may comprise one or more mechanical, electric and/or electronic members, which are apparently connected for operation of the slats 4.

An electric motor, for instance, maybe remotely controlled using a remote-control unit.

Furthermore, the upper structure may have one or more rods extending therefrom, and connected to rotating members for rotation thereof.

The Venetian blind 3 may optionally comprise a lower structural element (not shown in the accompanying figures), which is placed below the last slat 4, i.e. at a smaller distance from the walkway surface, to facilitate the movement of the slats.

Each of the slats 4 comprises at least two through holes 41 for the passage of the lift cords 5 through the slats 4.

The through holes 41 may be formed by punching of the slats 4.

The slats 4 are preferably made of painted or anodized aluminum, which will impart rigidity, light weight and whether or chemical resistance thereto.

The slats 5 predominantly extend in a longitudinal direction, preferably have a rectangular shape and/or may be also curved along a preset axis of extension.

According to a preferred embodiment, each slat 4 has a rectangular shape in which a pair of sides has a greater linear length than the other pair of sides.

In the exemplary embodiment of the accompanying figures, each slat 4 comprises two through holes 41.

In one aspect, in each slat 4 the two holes 41 are formed with a given pitch, i.e. the centers of the individual through holes 41 of each slat 4 are at the same distance from the edges of the slat.

The through holes 41 of the various slats 4 are formed in coaxial positions. Particularly a common axis X-X is provided for the first holes of the slats and another common axis X′-X′ is provided for the second holes of the slats 4. The axes X-X and X′-X′ extend in a vertical direction oriented from the upper structure to the lower area of the insulated glazing unit (or vice versa).

Further common axes may be provided if each slat has more than two holes.

The holes 41 will have such a size as to allow the passage of the cords 5.

In the preferred embodiment, there are also two lift cords 5.

Nevertheless, more than two holes 41 may be provided for each slat 4, with more than two lift cords.

The lift cords 5 are operably associated with the upper structure and extend through the holes 41 in the slats 4.

In the example of the accompanying figures, two cords 5 are provided and each lift cord 5 extends through the through holes 41 that lie on the first common axis X-X and the other cord extends through the through holes 41 that lie on the second common axis X′-X′.

The lift cords 5 are designed to be actuated or driven to allow the Venetian blind to switch from a stowed position in which the slats 4 accumulate proximate to the upper structure 6 and a deployed position in which the slats 4 cover a portion of the insulated glazing unit 2.

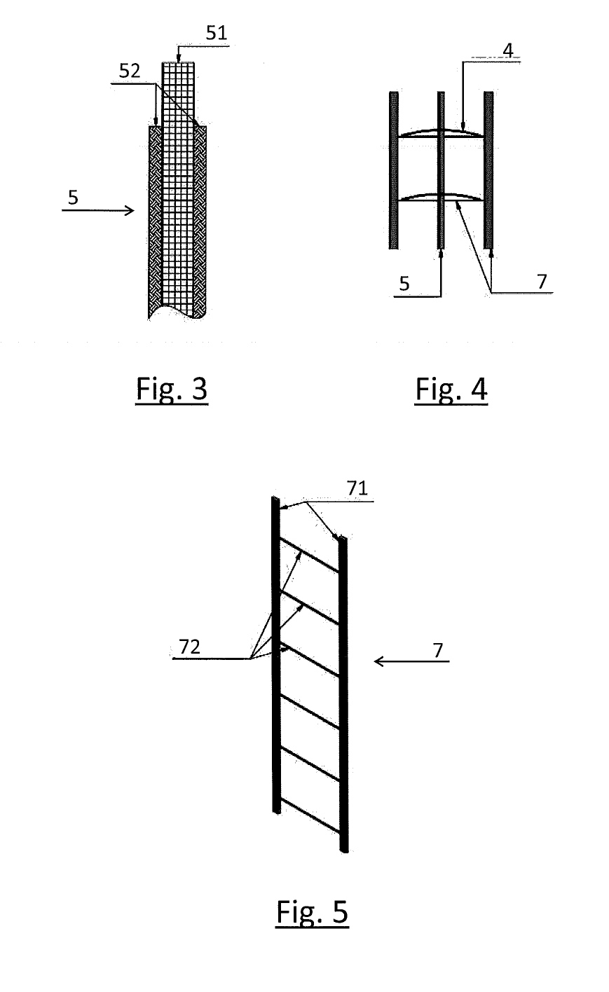

In a preferred aspect of the present disclosure, referring to FIG. 3, which shows a lateral sectional view of a lift cord, the lift cord 5 comprises an inner core 51 enclosed in an outer braid 52.

Particularly, the inner core 51 of each lift cord 5 is made of heat-set polyester, i.e. a material that imparts dimensional stability to the cord.

The outer braid 52 of the lift cord 5 is made of ultra-high molecular weight polyethylene fibers (UHMWPE), also known with the trade name Dyneema®.

A lift cord 5 formed with an inner core 51 made of heat-set polyester and an outer braid made of UHMWPE advantageously prevents damages to the lift cord 5 during the operations required to switch between the stowed position and the deployed position, when the lift cord 5 may rub against the edges of the holes 41.

These operations are also facilitated by low friction.

Advantageously, heat-set polyester does not shrink at the temperatures that are typically attained in an insulated glazing unit. Also, heat-set polyester is not excessively rigid, and the lift cords 5 can extend to a perfectly straight position during movement of the slats 4 and assembly of the blind 3.

It shall be further noted that, when high temperatures are reached within the insulated glazing unit, the lift cords 5 formed with the inner core made of heat-set polyester and the outer braid made of UHMWPE will not be shortened, as the outer braid 52 will stretch while adhering to the inner core 51.

In a peculiar aspect, the inner core 51 has a thickness ranging from 0.6 mm to 0.9 mm, preferably of 0.7 mm or 0.8 mm.

The outer braid 52 preferably has a thickness ranging from 0.05 mm to 0.2 mm, preferably of 0.1 mm.

Namely, with the combination of the such determined thicknesses, the lift cords 5 will be both resistant to wear due to the presence of the outer braid 52 and not excessively rigid, due to the small thickness of the outer braid 52 and the low rigidity of the inner core 51.

Referring now to FIGS. 4 and 5, the Venetian blind 3 may comprise at least two ladders 7 mechanically connected to the upper structure and operable to allow the slats 4 to be oriented between a screening position, in which the slats 4 block light from entering through the Venetian blind 3, and a non-screening position, in which the slats 4 allow light to pass through the Venetian blind 3.

Each of the ladders 7 may comprise two upright members 71 and a series of equally spaced connecting links 72 extending between the upright members 71. Each slat of the plurality of slats 4 may lie on the connecting links 72, i.e. the elements that bridge the two cords.

In a preferred aspect of the present invention, the connecting links 72 are made of ultra-high molecular weight polyethylene fibers (UHMWPE) or Dyneema®.

It shall be noted that in addition to ultra-high molecular weight polyethylene fibers (UHMWPE) or Dyneema® these connecting links may also comprise other materials, such as heat-set polyester.

Advantageously, this material will hinder the wear of the connecting links 72 caused by rubbing thereof against the edges of the slats 4 during orientation of the slats 4.

In a preferred aspect of the present invention, the upright members 71 are made of materials having stability properties, such as heat-set polyester.

Advantageously, this material allows the upright members 71 to extend to a perfectly straight position without changing its length as a result of temperature changes.

Those skilled in the art will obviously appreciate that a number of changes and variants may be made to the above described insulated glazing and Venetian blind system, to fulfill particular requirements, without departure from the scope of the invention, as defined in the following claims.

1. A combined insulated glazing and Venetian blind system, said insulated glazing comprising two glass panes and a spacer element, said two glass panes and said spacer element defining a closed volume, said Venetian blind being situated within said closed volume, said Venetian blind comprising an upper structure, a plurality of slats, each comprising at least two through holes, and at least two lift cords, operably associated with said upper structure, which extend through said holes of said slats and are operably configured to allow said slats to move between a stowed position, in which said slats accumulate proximate to said upper structure and a deployed position, characterized in that said lift cords comprise an inner core enclosed in an outer braid, said inner core being made of heat-set polyester and said outer braid being made of ultra-high molecular weight polyethylene fibers.

2. A combined insulated glazing and Venetian blind system as claimed in claim 1, wherein said inner core has a thickness ranging from 0.6 mm to 0.9 mm, and said outer braid has a thickness ranging from 0.05 mm to 0.2 mm.

3. A combined insulated glazing and Venetian blind system as claimed in claim 1, comprising at least two ladders mechanically connected to the upper structure and configured to allow said slats to be oriented between a screening position, in which said slats block light from entering through said Venetian blind, and a non-screening position, in which said slats allow light to pass through said Venetian blind.

4. A combined insulated glazing and Venetian blind system as claimed in claim 3, wherein each of said ladders comprises two upright members and a series of equally spaced connecting links which extend between said posts, said slats lying on said connecting links.

5. A combined insulated glazing and Venetian blind system as claimed in claim 4, wherein said upright members are made of heat-set polyester.

6. A combined insulated glazing and Venetian blind system as claimed in claim 4, wherein said connecting links are made of ultra-high molecular weight polyethylene fibers.
